(19) United States
(12) Patent Application Publication
(10) Pub. No.: US 2016/0016767 A1
(43) Pub. Date: Jan. 21, 2016

(54) METHOD AND APPARATUS FOR LIFTING AND SUPPORTING STORAGE TANKS

(71) Applicant: Robert L. Jones, Golden, CO (US)

(72) Inventor: Robert L. Jones, Golden, CO (US)

(21) Appl. No.: 14/722,421

(22) Filed: May 27, 2015

Related U.S. Application Data
(60) Provisional application No. 62/026,808, filed on Jul. 21, 2014.

(51) Int. Cl. B66F 3/46; B66F 3/08

(52) U.S. Cl. CPC B66F 3/46; B66F 3/08

(57) ABSTRACT

A method and apparatus for lifting and supporting a storage tank uses a series of lifting devices on piles spaced around the periphery of the tank. Each lifting device includes a lower threaded bar with a coupler that engages the upper end of a pile. A lifting bracket is inserted under or attached to the tank, and includes a tube that slides along the lower threaded bar. A plurality of upper threaded bars extend upward from the lifting bracket and pass through a horizontal beam that can slide vertically on them. Upward movement of the horizontal beam is limited by nuts on the upper threaded bars. A jack is placed between the horizontal beam and the lower threaded bar to raise the lifting bracket by exerting upward force on the horizontal beam. The lifting bracket can be held in this raised position by a nut on the lower threaded bar.

### RELATED APPLICATION

The present application is based on and claims priority to the Applicant's U.S. Provisional Patent Application 62/026,808, entitled “Method and Apparatus for Lifting and Supporting Storage Tanks,” filed on Jul. 21, 2014.

### BACKGROUND OF THE INVENTION

1. Field of the Invention

The present invention relates generally to the field of systems for lifting and supporting storage tanks. More specifically, the present invention discloses a method and apparatus for lifting and supporting storage tanks using piles.

2. Statement of the Problem

Large above-ground storage tanks have been used for many years in a variety of industries for holding water, petroleum, chemicals and other fluids. In the oil and gas industry, storage tanks are widely used at the well head, at pumping and storage facilities, at refineries and processing facilities, and at shipping locations. These storage tanks are typically made of relatively thin sheet metal and are designed for handling structural loads normally associated with fluid storage. However, most storage tanks are not particularly well-designed to handle the much larger stresses that can be encountered in lifting or repositioning a tank after its initial construction (e.g., during maintenance or repair of the tank). This renders many storage tanks susceptible to structural damage when lifted for repair or maintenance unless great care is take during the lifting operation.

In addition, storage tanks in the oil and gas industry are often deployed in remote locations, and are commonly constructed on a rudimentary pad with little or no foundation supporting the tank. This can result in the excessive or uneven settling of the tank over time, that typically requires the tank be lifted, repositioned or leveled. There is also often a need to increase the size of an existing storage tank after it has been installed in the field. This augmentation process is typically done by lifting the existing tank and adding to the structure around the bottom of the tank.

The most common conventional technique for lifting a large storage tank employs a series of jacks placed beneath tank around intervals around its circumference. The jacks are actuated to lift the entire tank a short vertical distance so that wooden cribbing (e.g., railroad ties) can be inserted under the tank for temporary support. The jacks are then removed and repositioned on the cribbing, so they can lift the tank again, after which additional cribbing is inserted, etc. This process of jacking and cribbing can be repeated until the tank has been lifted to a desired elevation. An example of this general technique is described in U.S. Pat. Nos. 4,930,750 and 4,807,851 (De Castro).

There are many drawbacks associated with this conventional approach. The wooden cribbing must be stacked directly beneath the storage tank, which often requires heavy manual labor and can be dangerous if the cribbing, jacks, or tank structure give way. In addition, this approach is relatively slow due to the manual labor required and the incremental process of actuating each jack and inserting individual timbers beneath the tank.

Solution to the Problem. The present invention provides a method and apparatus for use with piles in lifting and supporting storage tanks in the field. This approach is much safer, faster, less labor-intensive and more efficient than previous methods using conventional jacks and cribbing. In addition, the piles and lifting devices are generally located slightly outside the periphery of tank, with only a small portion of the lifting devices extending directly under the tank to increase safety. Furthermore, the piles used in the present invention remain in place after the lifting operation is complete, and can be incorporated into a permanent foundation for the storage tank.

### SUMMARY OF THE INVENTION

This invention provides a method and apparatus for lifting and supporting a storage tank using a series of lifting devices on piles spaced around the periphery of the tank. Each lifting device includes a lower threaded bar with a coupler that engages the upper end of a pile. A lifting bracket is inserted under the tank and includes a tube that slides along the lower threaded bar. Two upper threaded bars extend upward from the lifting bracket and pass through a horizontal beam that can slide vertically on these upper threaded bars. Upward movement of the horizontal beam is limited by two nuts on the upper threaded bars. A jack is placed between the horizontal beam and upper end of the lower threaded bar. The jack can be used to raise the lifting bracket by exerting upward force on the horizontal beam, which lifts the two upper threaded bars and the lifting bracket. The lifting bracket can be held in this raised position by moving a nut on the lower threaded bar upward against the bottom of the lifting bracket. An hydraulic control system can be employed to simultaneously actuate the jacks of all of the lifting devices in a coordinated manner to lift a storage tank.

These and other advantages, features, and objects of the present invention will be more readily understood in view of the following detailed description and the drawings.

### BRIEF DESCRIPTION OF THE DRAWINGS

The present invention can be more readily understood in conjunction with the accompanying drawings, in which:

FIG. 1 is a left side view of an embodiment of the lifting device 30 on a storage tank 10.

FIG. 2 is a front view of the lifting device 30 and storage tank 10 corresponding to FIG. 1.

FIG. 3 is a top view showing a plurality of lifting devices 30a-30f spaced around the circumference of a storage tank 10.

FIG. 4 is a detail cross-sectional view of the lower portion of the lifting device attached to the upper end of a pile 20 in a pit 16 in the ground 15 adjacent to a storage tank 10.

FIG. 5 is a front view of the lifting device 30 with the jack 40 lowered.

FIG. 6 is a front view of the lifting device 30 corresponding to FIG. 5 after the jack 40 has been raised.

FIG. 7 is a front view of the lifting device 30 corresponding to the FIGS. 5 and 6 after the lower nut 28 has been threaded upward against the bottom of the lifting bracket.

FIG. 8 is a left side view of an alternative embodiment of the lifting device 30 on a storage tank 10.

FIG. 9 is a top view corresponding to FIG. 8.

### DETAILED DESCRIPTION OF THE INVENTION

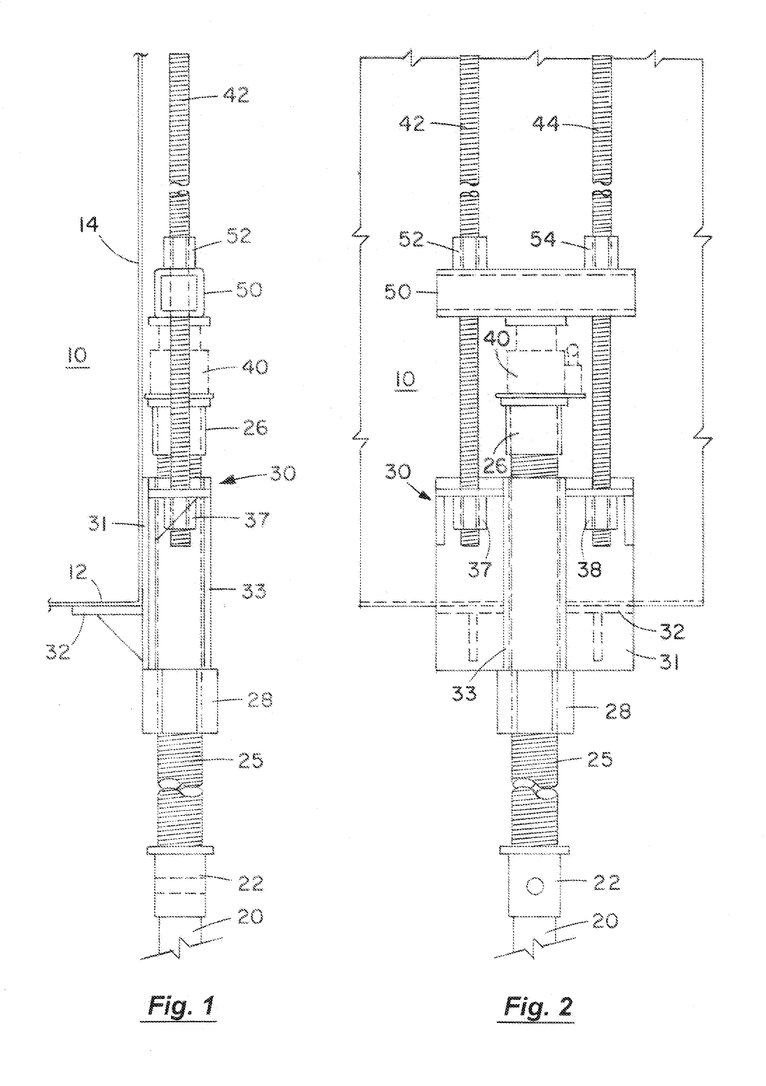

FIGS. 1 and 2 show corresponding side and front views of an embodiment of the present lifting device 30 used for lifting and supporting a storage tank 10 on a pile 20. The pile 20 can be a conventional helical pile with one or more helical blades mounted on the lower end of a shaft. Only the upper end of the shaft of the pile 20 is shown in FIGS. 1 and 2.

The primary components of the lifting device 30 include a lower threaded bar 25 with a coupler 22 on its lower end to engage the upper end of the a pile 20. A vertical tube 33 slides freely over the threaded bar 25 and is attached to the front of a vertical plate 31. This vertical plate 31, together with a horizontal plate 32 extending from its rear surface, form an L-shaped lifting bracket for lifting a tank 10 as illustrated in FIG. 1. In other words, the vertical tube 33 and plates 31, 32 define a lifting bracket that slides vertically on the lower threaded bar 25 to lift the tank 10. A nut 28 threaded on the lower threaded bar 25 serves as an adjustable downward limit on the elevation of the lifting bracket on the lower threaded bar 25.

A plurality of upper threaded bars 42 and 44 extend upward from the lifting bracket. Preferably, there are two upper threaded bars 42, 44 extending upward from the left and right sides of the lifting bracket, as shown FIG. 2. These upper threaded bars 42, 44 are generally parallel to, but laterally offset from the lower threaded bar 25 as also depicted in FIG. 2. The lower ends of the upper threaded bars 42, 44 are adjustably secured to the lifting bracket by two nuts 37 and 38.

A horizontal beam 50 extends between the upper threaded bars 42, 44, with vertical holes adjacent to either end that allow the horizontal member 50 to slide freely on the upper threaded bars 42, 44. Two nuts 52, 54 on the upper threaded bars 42, 44 adjustable limit upward motion of the horizontal beam 50 on the upper threaded bars 42, 44. Preferably, the horizontal beam 50 has a hollow structural section (HSS), although other cross-sections could be used.

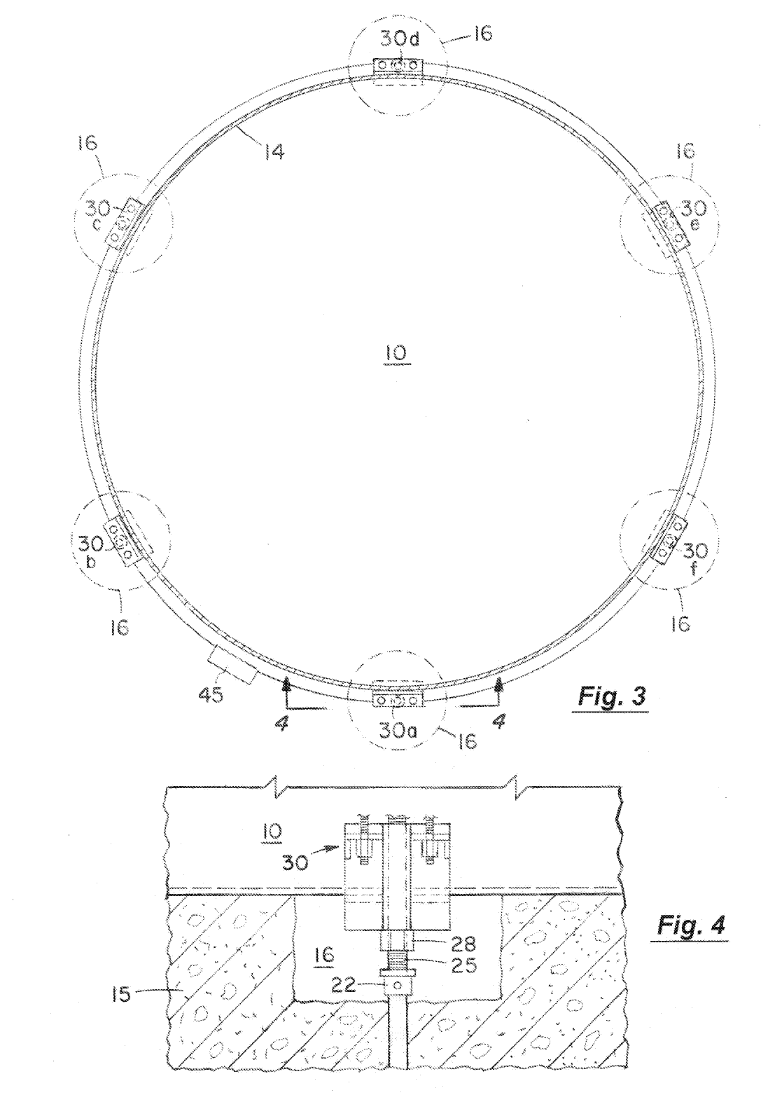

A cap 26 is placed on the upper end of the lower threaded bar 25 to support a jack 40 between horizontal beam 50 and the upper end of the lower threaded bar 25 that is coupled to the pile 20. Preferably, the jack 40 is hydraulically or pneumatically actuated. This enables an array of jacks spaced about the periphery of a tank 10 to be simultaneously operated in a coordinated manner by a control system 45, as shown in FIG. 3.

The following is a description of the method by which the present invention can be used to lift a storage tank 10. First, the appropriate number and spacing of piles 20 and lifting devices 30a-30f should be selected based on size, weight, configuration, structural properties and condition of the particular storage tank to be lifted, as well as local geological conditions. Typically, a plurality of piles 20 and lifting devices are installed at intervals around the periphery of the storage tank 10, as shown in the top view provided in FIG. 3. The piles 20 should have a suitable capacity with appropriate spacing to transfer the tank loads to the subsurface soils.

A pit 16 is excavated at the intended location for each lifting device 30a-30f adjacent to the periphery of the tank 10, as shown for example in FIG. 4. For example, the pit can be roughly 24 inches by 24 inches in area and extend approximately one foot below the bottom 12 of the tank 10. The centerline of the pit 16 can be located in vertical alignment with the intended location of the pile 20 and the lifting device 30, which is typically about 2 to 2½ inches outboard of the outer side of the tank wall 14. It should be understood that the various dimensions and tolerances specified in this disclosure are only for the purposes of example, and should not be construed as limiting the scope of the present invention.

If a chime exists below the tank wall, it should be removed at least from the regions of the tank that will be in contact with the lifting devices 30a-30f.

For a typical lifting device, this would entail a region of about 13 inches of chime removal for each lifting device.

A pile 20 is then installed at each location where a lifting device 30a-30f is to be placed. For example, the pile 20 can be a conventional helical pile that is installed by threading the helical blade of the helical pile into the ground beneath the pit 16 until the top of the helical pile 20 is about 7-9 inches below the bottom 12 of the tank 10. The lifting device 30 is placed on top of the pile 20 with the coupler 22 on the lower end of the lower threaded bar 25 engaging the upper end of the shaft of the pile 20.

Using the lower nut 28, the lifting device 30 is secured tightly under the tank 10, with the vertical plate 31 of the lifting bracket flush against the tank side wall 14 and the horizontal plate 32 of the lifting bracket tight against the tank bottom 12. If desired, the vertical plate 31 may be welded to the tank wall 14 around the edges of the vertical plate 31.

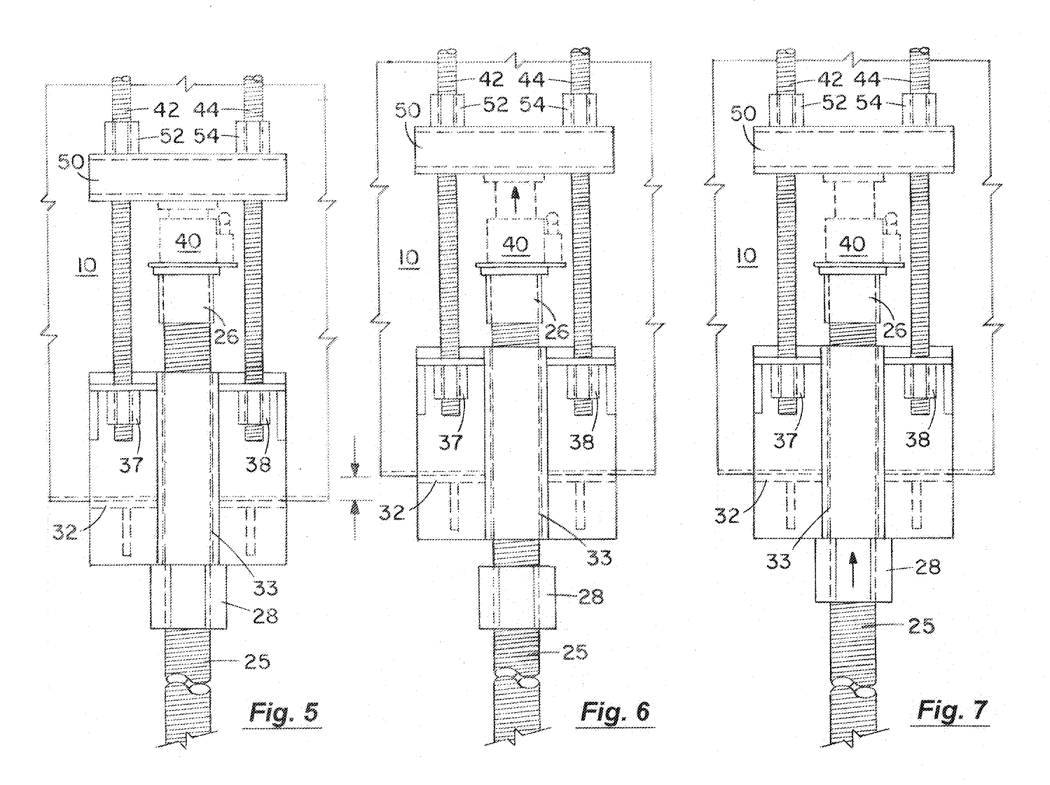

A jack 40 (e.g., an hydraulic jack) is removably inserted into the space between the cap 26 and the underside of the horizontal beam 50, as shown in FIGS. 1, 2 and 5. To hold the jack 40 in place, the upper nuts 52, 54 are screwed downward tightly against the top of the horizontal beam 50 on the upper threaded bars 42 and 44, and the lower nuts 37, 38 are screwed upward tightly against the lifting plates near the top of the vertical plate 31, as shown in FIG. 5. It is important to leave a sufficient length of threaded bar 25 between the top of the tube 33 and the cap 26 to accommodate the amount of tank lift required in each phase of the procedure.

Next, the tank 10 is lifted to its desired new vertical position by jacking against the underside of the horizontal beam 50, as shown in FIG. 6. A hydraulic control system 45 shown in FIG. 3 can be employed to simultaneously actuate a plurality of jacks 40 associated with an array of lifting devices 30a-30f spaced around the circumference of a tank 10 to ensure that the tank 10 is raised evenly in a predetermined manner to avoid excessive localized stress. For example, the control system can be used to actuate the jacks 40 in a coordinated manner to maintain the tank 10 in a substantially level orientation as it is raised. When the tank 10 is in its new vertical position, the lower nut 28 is screwed upward tightly against the bottom of the vertical tube 33 of each lifting device 30a-30f as shown in FIG. 7. The lower nut 28 can be hand-tightened. The steps illustrated in FIGS. 5-7 can be repeated as necessary depending on the desired elevation.

The present system can also be employed to lower the tank 10 after tank augmentation, repair or foundation work has been completed. This is done by moving the lower nuts 28 downward on the lower threaded bar 25 of each lifting device 30, so that the vertical tube 33 can slide downward to a desired elevation. The jacks 40 are then actuated to lower the horizontal beam 50, upper threaded bars 42, 44 and lifting bracket 31, 32, and thereby lower the storage tank 10 to its desired elevation.

At that point, the jack 40 and the upper portions of the lifting device 30 (i.e., nuts 37, 38, 52 and 54, upper threaded bars 42, 44, horizontal beam 50, and cap 26) can be released and removed. This leaves the tank 10 being supported by the remaining lower portions of the lifting device 30 (i.e., the horizontal plate 32, vertical plate 31, vertical tube 33, lower nut 28, lower threaded bar 25 and coupler 22) on the pile 20. Tank augmentation, repair or foundation work can now be accomplished. The present lift support system can be used to re-position the tank as required during this process.

After this work has been completed, the remaining components of the lifting devices 30 and the piles 20 can be left place. These components can be embedded in concrete as parts of the foundation for the tank. The pit 16 can be backfilled as appropriate. Alternatively, the lifting devices 30 can be removed entirely after the work has been completed, although the piles 20 are typically left in place in the ground 15. If desired, the upper ends of the piles 20 can be embedded in concrete to provide a foundation for the tank 10. In this embodiment, the foundation is at least partially supported by the piles 20. If the lower portions of the lifting device 30 (i.e., lifting bracket 31, 32, 33, lower threaded bar 25 and coupler 22) are left in place on upper end of each pile 20, some or all of these remaining components can also be embedded in the concrete foundation for the tank 10.

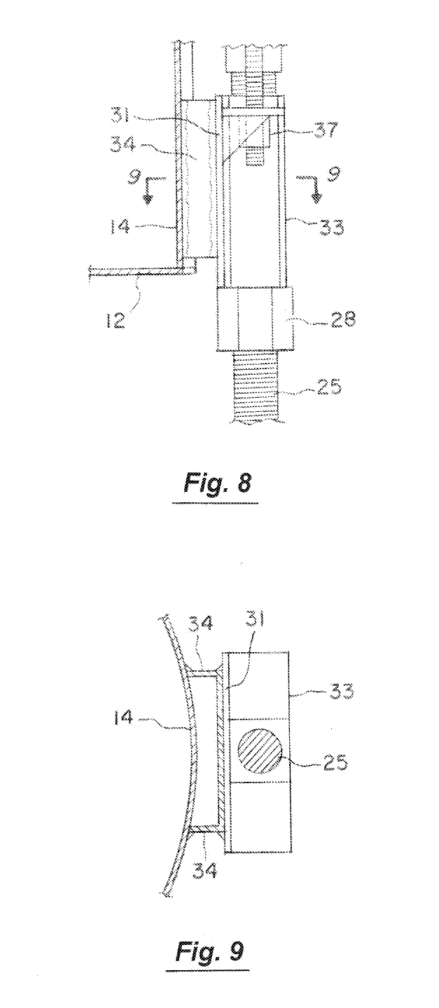

FIGS. 8 and 9 show an alternative embodiment of a lifting device 30 welded to the side wall 14 of a tank 10. In particular, the L-shaped lifting bracket 31, 32 in FIG. 1 has been replaced by a vertical plate 31 with two vertical side plates 34 that can be welded directly to the side wall 14 of the tank 10. As shown in FIG. 8, the tank floor 12 sometimes extends outward beyond the tank wall 14. This embodiment eliminates having to cut the chine ring or floor 12 extending beyond the tank wall 14 to fully seat an L-shaped lifting bracket. In addition, this embodiment also has the safety advantage that nothing projects under the tank wall 14 or floor 12.

The above disclosure sets forth a number of embodiments of the present invention described in detail with respect to the accompanying drawings. Those skilled in this art will appreciate that various changes, modifications, other structural arrangements, and other embodiments could be practiced under the teachings of the present invention without departing from the scope of this invention as set forth in the following claims.

I claim:

1. A method for lifting and supporting a storage tank comprising:
driving a plurality of piles into the ground spaced around the periphery of the storage tank;
providing a corresponding plurality of lifting devices having:
(a) a lower threaded bar with a coupler for engaging the upper end of a pile;
(b) a lifting bracket for lifting the storage tank and having a tube sliding along the lower threaded bar;
(c) a plurality of upper threaded bars extending upward from the lifting bracket;
(d) a horizontal beam sliding vertically on the upper threaded bars;
(e) nuts on the upper threaded bars adjustably limiting upward movement of the horizontal beam on the upper threaded bars;
(f) a jack removably placed between the horizontal beam and lower threaded bar, said jack exerting upward force on the horizontal beam to lift the upper threaded bars and lifting bracket, while the tube of the lifting bracket slides along the lower threaded bar; and
(g) a nut on the lower threaded bar adjustably limiting downward movement of the lifting bracket on the lower threaded bar;
coupling each lifting device to the upper end of a pile, with the lifting bracket of the lifting device inserted under the storage tank;
actuating the jacks of the lifting devices to raise the storage tank to a desired elevation; and
moving the nut upward on the lower threaded bar of each lifting device against the lifting bracket to hold the storage tank in the raised position.

2. The method of claim 1 further comprising a control system simultaneously actuating the jacks in a coordinated manner to raise the storage tank.

3. The method of claim 2 wherein the control system actuates the jacks to raise the storage tank while maintaining a level orientation.

4. The method of claim 1 further comprising removing the jack, upper threaded bars and horizontal beam from each lifting device, while leaving in place the lower threaded bar and lifting bracket supporting the storage tank.

5. The method of claim 1 further comprising lowering the storage tank by:
moving the nuts downward on the lower threaded bar of each lifting device; and
actuating the jacks of the lifting devices to lower the storage tank to a desired elevation.

6. The method of claim 1 further comprising pouring a concrete foundation for the storage tank supported at least in part by the piles.

7. The method of claim 6 wherein the lower threaded bars and lifting brackets are embedded in the concrete foundation.

8. A method for lifting and supporting a storage tank comprising:
driving a plurality of piles into the ground spaced around the periphery of the storage tank;
providing a corresponding plurality of lifting devices having:
(a) a lower threaded bar with a coupler for engaging the upper end of a pile;
(b) a lifting bracket for lifting the storage tank and having a tube sliding along the lower threaded bar;
(c) a plurality of upper threaded bars extending upward from the lifting bracket;
(d) a horizontal beam sliding vertically on the upper threaded bars;
(e) nuts on the upper threaded bars adjustably limiting upward movement of the horizontal beam on the upper threaded bars;
(f) a jack removably placed between the horizontal beam and lower threaded bar, said jack exerting upward force on the horizontal beam to lift the upper threaded bars and lifting bracket, while the tube of the lifting bracket slides along the lower threaded bar; and
(g) a nut on the lower threaded bar adjustably limiting downward movement of the lifting bracket on the lower threaded bar;
coupling each lifting device to the upper end of a pile, with the lifting bracket of the lifting device inserted under the storage tank;
providing a control system for actuating the jacks of the lifting devices;
operating the control system to simultaneously actuate the jacks of the lifting devices in a coordinated manner to raise the storage tank to a desired elevation; and
moving the nut upward on the lower threaded bar of each lifting device against the lifting bracket to hold the storage tank in the raised position.

9. The method of claim 8 wherein the control system actuates the jacks to raise the storage tank while maintaining a level orientation.

10. The method of claim 8 further comprising removing the jack, upper threaded bars and horizontal beam from each lifting device, while leaving in place the lower threaded bar and lifting bracket supporting the storage tank.

11. The method of claim 8 further comprising lowering the storage tank by:
moving the nuts downward on the lower threaded bar of each lifting device; and
operating the control system to actuate the jacks of the lifting devices to lower the storage tank to a desired elevation.

12. The method of claim 8 further comprising pouring a concrete foundation for the storage tank supported at least in part by the piles.

13. The method of claim 12 wherein the lower threaded bars and lifting brackets are embedded in the concrete foundation.

14. A lifting device for lifting and supporting a storage tank comprising:
a lower threaded bar with a coupler for engaging the upper end of a pile;
a lifting bracket for lifting the storage tank and having a tube sliding along the lower threaded bar;
a plurality of upper threaded bars extending upward from the lifting bracket;
a horizontal beam sliding vertically on the upper threaded bars;
nuts on the upper threaded bars adjustably limiting upward movement of the horizontal beam on the upper threaded bars;
a jack removably placed between the horizontal beam and lower threaded bar, said jack exerting upward force on the horizontal beam to lift the upper threaded bars and lifting bracket, while the tube of the lifting bracket slides along the lower threaded bar; and
a nut on the lower threaded bar adjustably limiting downward movement of the lifting bracket on the lower threaded bar.

15. The lifting device of claim 14 further comprising a control system coordinating actuation of the jack with other lifting devices.

16. The apparatus of claim 14 wherein the horizontal beam and upper threaded bars are removable from the lifting bracket.
